(19) United States
(12) Patent Application Publication
(10) Pub. No.: US 2020/0389963 A1
(43) Pub. Date: Dec. 10, 2020

(54) LIGHTING CONTROLLER

(71) Applicant: SIGNIFY HOLDING B.V., EINDHOVEN (NL)

(72) Inventors: MARJOLEIN DIMMIE VAN DER ZWAAG, EINDHOVEN (NL); JONATHAN DAVID MASON, WAALRE (NL); DZMITRY VIKTOROVICH ALIAKSEYEU, EINDHOVEN (NL)

(21) Appl. No.: 16/464,002

(22) PCT Filed: Nov. 16, 2017
(86) PCT No.: PCT/EP2017/079454

§ 371 Date: May 24, 2019

(30) Foreign Application Priority Data
Nov. 24, 2016 (EP) 16200507.8

(51) Int. Cl. H05B 47/11; H05B 47/19; G05B 19/042; G06Q 30/06

(52) U.S. Cl. CPC H05B 47/11; G06Q 30/0641; G05B 19/042; H05B 47/19

(57) ABSTRACT

The invention provides a lighting controller (100) for regulating a user internet activity performed on a user device (104), wherein the user internet activity performed on the user device comprises an online monetary transaction, wherein the lighting controller (100) comprises a processor (101) arranged for: receiving information (102) indicating the user internet activity on the user device (104); processing said information (102) to obtain a control signal (103) for controlling a light source (105) to change at least one lighting characteristic from the group of color temperature; and regulating the user internet activity by supplying the control signal to control the light source for encouraging a user to perform the online monetary transaction by a decrease in color temperature, or for discouraging the user to perform the online monetary transaction by an increase in color temperature.

### FIELD OF THE INVENTION

The invention relates to a lighting controller for regulating a user internet activity performed on a user device. The invention further relates to a lighting system comprising said lighting controller and a light source. The invention moreover relates to a lighting system comprising said lighting controller, a light source and a user device. The invention further relates to a method performed by a lighting controller and a computer program product.

### BACKGROUND OF THE INVENTION

Such a lighting controller is known from US2016/0029458A1, in which a system for adaptive lighting is disclosed that determines the mood or lighting needs of a user, derives an appropriate lighting scheme, and then implements that lighting scheme on all devices within a predetermined proximity to that user.

To be more specific: The user's situation is determined first by determining a profile of both what the user is likely to be doing next and the general mood of the user. This is based at least in part on contextual information obtained from the user's devices and/or sensors, including amongst others web interactions by the user. Based on the contextual information a user task is inferred and a lighting need associated with the user task.

Although such a system provides anticipatory lighting to a user, a disadvantage of such a system remains that it is still limited in providing adaptive lighting conditions during a particular user task itself.

### SUMMARY OF THE INVENTION

It is an object of the invention to provide an improved lighting controller, which is able to regulate a user internet activity performed on a user device by controlling a light source. Thereto, the invention provides a lighting controller for regulating a user internet activity performed on a user device, wherein the user internet activity performed on the user device comprises an online monetary transaction, wherein the lighting controller comprises a processor arranged for: receiving information indicating the user internet activity on the user device; processing said information to obtain a control signal for controlling a light source to change a lighting characteristic from the group of color temperature; and regulating the user internet activity by supplying the control signal to control the light source for encouraging a user to perform the online monetary transaction by a decrease in color temperature, or discouraging a user to perform the online monetary transaction by an increase in color temperature.

Hence inducing a change in the user internet activity performed on the user device during the user internet activity, or inducing the user to change the user internet activity performed on the user device during the user internet activity, may be read in this application as encouraging a user to perform the online monetary transaction by a decrease in color temperature, or discouraging the user to perform the online monetary transaction by an increase in color temperature; or may be read as influencing a user to encourage the online monetary transaction by a decrease in color temperature, or to discourage the online monetary transaction by an increase in color temperature.

Such a lighting controller may provide a regulating means to regulate a user internet activity performed on a user device. Such a lighting controller is particularly suited for a user internet activity performed on a user device that benefits from regulatory action, such as for example repetitive, decisional or addictive activities. Research indicates that controlling a light source may not only influence the mood or well-being of people, but it may also induce a change (e.g. encouragement or discouragement) in activities performed on a user device, such as user internet activities. An example from research is the exposure of users to warmer light conditions or colder light conditions, which are using a user device for online shopping, in which warmer light appears to encourage the shopping behavior, while colder light discourages shopping behavior. Controlling a light source may thus induce a change in user activity. In addition, experimental research in the field of lighting psychology indicates that donations increase at warmer light conditions; and that monetary transactions increase in warmer colored lighting conditions compared to cooler colored lighting conditions. The research also applies to mutual trust during an activity comprising the notion of trust, e.g. like a negotiating meeting or customer service call, in which mutual trust may increase in warmer colored lighting environments compared to cooler colored lighting environments.

For example, as known in textbooks on lighting, color temperature of white light may be perceived as cold-white at 5000-7000 Kelvin, while white light may be perceived as warm white up to 3000 Kelvin. Neutral white light may have a color temperature of 4000 Kelvin. Warm white light creates an informal inviting ambient lighting environment, while neutral or cold white light creates a more formal lighting environment. The full spectrum of white light, as indicated by the Planckian locus in the C.I.E. color space, reflects the color temperature range within the C.I.E. color space. Colors near this curve might be associated with warmer or cooler colors, for example red as a warmer color (as it is close to the above mentioned cooler color temperatures) and blue as a cooler color (as it is close to the above mentioned warmer color temperatures).

For example, warmer light may be warm white (lower color temperatures) and/or colors that have an association with warmth like reddish colors. Similarly, cooler light may be cold white (higher color temperatures) and/or colors that have an association with cooler environments like blue.

Hence, specific lighting conditions may be used to induce a change in user activity, for example user internet activity. Further, a user activity may only be encouraged, discouraged or both dynamically.

In the present invention, the user internet activity (or the content of the user internet activity, or the actions performed during user internet activity, hence active properties performed on the user device) itself may be processed to obtain a control signal for controlling a light source to change at least one lighting characteristic from the group of color, intensity, color temperature and modulation. For example, when the user internet activity is performed on a display of the user device, the specific user internet activities performed on said display (and not the display properties of said display) will be processed to obtain said control signal for controlling a light source. The present invention thus provides an improved lighting controller for regulating a user internet activity performed on a user device.

Furthermore, the control signal to control the light source for inducing a change in the user internet activity performed on the user device may be supplied during the user internet activity; because the lighting controller for regulating the user internet activity may be more effective in its regulatory action when it occurs during the user internet activity. For example, in case an user internet activity is opening a shopping website or adult website, while this is not desired, the lighting controller according to the invention may regulate the user internet activity by supplying a control signal to control the light source for encouraging a user to perform the online monetary transaction by a decrease in color temperature, or discouraging a user to perform the online monetary transaction by an increase in color temperature, whenever the user internet activity comprises opening such an undesired adult or shopping website. Hence, during the user internet activity, the control signal is supplied for direct regulatory action.

Further, in obtaining the control signal, the lighting controller may also be able to assess stored information, next to the real-time received information. Hence, in an embodiment, the lighting controller according to the present invention is provided, wherein the processor is further arranged for: storing information in a memory indicating the user internet activity on the user device; and accessing the memory for additionally receiving the stored information to be able to additionally assess the stored information in obtaining the control signal. Consequently, the lighting controller is able to access said memory for additionally receiving stored information, such that this information may be taken into account when all the received information is processed to obtain the control signal. Making use of stored information may be advantageous, because a more complicated and accurate control signal may be obtained for controlling the light source. For example, the stored information may comprise past records indicative of regulating the user internet activity, and/or cumulative information on the user internet activity. Said memory may be located in relation to the processor or alternatively in an external memory device, such as a flash memory device or a hard disk drive. The memory may be a memory added to user device or already present in the user device. The memory may also be accessible by the internet through the user device, such as a remote storage server.

Said control signal may thus be inferred from processing real-time received information and previously stored information. Said control signal may also comprise only real-time received information in case no stored information is required for regulating a user internet activity performed on a user device. Said control signal may be an electrical signal originating from the processor. Said control signal may be arranged for controlling a light to change at least one lighting characteristic from the group of color, intensity, color temperature and modulation. Said control signal may also comprise multiple signals, or multiple signals for multiple light sources, or signals for controlling light sources which are part of devices other than lighting devices. Said control signal may also comprise signals to individually control a light source within a plurality of light sources, such as e.g. a LED strip and only control specific parts of the LED strip.

Furthermore, said control signal may be obtained from processing database information next to the real-time received information and stored information. In an embodiment, the processor of the lighting controller according to the present invention may further be arranged for: accessing a database comprising database information for additionally receiving the database information to be able to additionally assess the database information in obtaining the control signal. This is advantageous for the regulatory action of the lighting controller, because database information retrieved from a database for obtaining said control signal may provide the lighting controller additional (or complementary) information on the user internet activity and the conditions for which regulation is desired.

In an embodiment, the database information may comprise financial data, health data or personal user information data. Tapping into a database for receiving database information on financial data may for example be beneficial to provide regulatory action to a user internet activity, because it may be known what the financial status is of a user using the user device for user internet activity. Financial data may be e.g. bank account data, online payment credit data, billing data, buying history, or income overview. Furthermore, receiving health data may be advantageous, because it may be determined whether or not the user using the user device for user internet activity is coping with an addiction. Health data may for example comprise real-time health data stored in an external database, which may indicate the physiological conditions of a user using the user device for user internet activity. This may be advantageous to take into account in obtaining the control signal, because the inducible change in user internet activity may be more effectively induced when knowing more about the current status of the user using the user device for a user internet activity. Health data may e.g. be a health report, current physiological parameter data like heartrate, respiration, sweat level, eye movement, or blood pressure. Personal information data may be formal institutional database data on a user which is using a user device for performing a user internet activity. Personal information data may also be customer data indicating the history of the customer transactions, comments or preferences.

Said database information may be obtained from a database on an external server, stored on an internal or external memory, or stored on a local external device such as a smartphone, smartwatch, and other wearable devices.

A lighting controller, as provided by the present invention, may therefore be advantageous for regulating a user internet activity performed on a user device; because a regulatory feedback loop is closed. During the user internet activity: a control signal is supplied to control a light source for encouraging a user to perform the online monetary transaction by a decrease in color temperature, or discouraging the user to perform the online monetary transaction by an increase in color temperature , which may be a control signal to change at least one lighting characteristic from the group of color temperature. The control signal may be obtained by processing information indicating the user activity on the user device. Hence, a regulatory feedback loop is closed for regulating said user internet activity.

The lighting controller may be a separate stand-alone controller. However, the controller may be bodily integrated with the user device, such that the user internet activity performed on the user device and the lighting controller for regulating said user internet activity are part of a single user device body while still being separate devices. This may facilitate the receiving and processing of the information indicating the user internet activity. Furthermore, the lighting controller may be part of an application or computer program product present on the user device. Alternatively, the lighting controller may be separate from the user device and located in connection with the light source. Yet alternatively, the lighting controller may be part of a separate stand-alone device, such as a bridge, smartphone that is not the user device, or a lighting controller device.

Said user device is a device suitable for performing a user internet activity. It is particularly suited for the activities mentioned in this application. As the user internet activity is performed on the user device, the device is connectable to the internet. This may be by a network connection, wireless network connection such as Wi-Fi, or alternative means of connecting to the internet by for example visible light communication (VLC), Infrared, ZigBee or Bluetooth. In an embodiment, the user device may be a handheld device. As many user internet activities are best performed on a handheld user device, it may be beneficial to provide such a user device with a lighting controller for regulating said user internet activity performed on the user device. Further, in an embodiment, said user device may be a smartphone, a tablet, a notebook, a personal computer, a game console, an e-reader, a smart fridge, or a smart TV. These devices may all be capable of performing user internet activities, of which a change in the user internet activity may be induced by supplying the control signal (of the present invention) during the user internet activity for controlling the light source.

Said user internet activity may be an interaction with the web, such as browsing pages connected to the internet, searching a search engine, running applications, performing a social media activity, chatting or texting, video calling, browsing catalogues downloaded from the internet, downloading files, gaming, gaming based on augmented reality, reading web articles, and sending or receiving information on the web, using applications on a smart television connected to the internet. Said user internet activity may also be performed on a local network or a private network.

Furthermore, in an embodiment, said user internet activity may be an indoor activity illuminated by artificial lighting. This is advantageous, because regulation of an indoor activity illuminated by artificial lighting may be more susceptible for regulatory action by means of the lighting controller, since an indoor activity illuminated by artificial lighting may be less affected by interferences of (less controllable) natural light conditions.

Said user internet activity performed on a user device may include an activity suitable for regulation by means of controlling a light source, wherein the lighting characteristics encourage or discourage said user internet activity and are able to induce a change in the user internet activity. Hence, in an embodiment, the user internet activity performed on the user device may comprise an activity from the group of shopping, banking, gambling, gaming, donations, rating, or pornography. It may be advantageous to regulate such activities by means of a lighting controller according to the present invention, because controlling the light source may provide a subtle means to induce a change in a user internet activity (or behavior). For example, controlling unobtrusive ambient light from colder (e.g. white) to warmer (e.g. white) light may stimulate donations made to a charity website or a crowdfunding webpage.

Here, for example: shopping may relate to online shopping, or more specific to online shopping for products on a webstore or marketplace. It may also relate to offline catalogue browsing of products of which the catalogue is downloaded from the web. It may further relate to online advertising, either to buy or to sell. By processing information indicating the online shopping for products on a user device, a control signal may be obtained for controlling a light source to change at least one lighting characteristic from the group of color, intensity, color temperature and modulation. Then, by supplying the control signal during online shopping for products, controlling the light source according to the control signal may induce a change in the online shopping activity on the user device. Hence, in case regulatory action is required to reduce the online shopping activity, the control signal for controlling the light source may comprise a signal to provide a colder color temperature ambient light to discourage the online shopping activity. On the other hand, in case regulatory action is required to increase the online shopping activity, the control signal for controlling the light source may comprise a signal to provide warmer color temperature ambient light. Similarly, controlling the light source may also induce a change in browsing through a catalogue of products. In case the browsing through a catalogue of products requires encouraging regulatory action, the control signal for controlling the light source may comprise a signal to provide colored light highlighting the colors of the products and brands in the catalogue. Alternatively, referring to the latter example, discouraging regulatory action may comprise colored light negatively impacting the colors of the products in the catalogue by e.g. reducing contrast or color differences.

Banking may, for example, relate to online bank transactions, preparing payments, or stock exchange activities. Gambling may, for example, relate to online gambling or buying gambling credit. Gaming may, for example, relate to online gaming, or buying in-game credits and/or game products. Donations may, for example, relate to online donations, or support to crowdfunding products. Rating may, for example, relate to rating of hotels, holidays, leisure activities, videos, social media posts, movies, series, websites, or consumer products. All references to pornography are references to adult and legal pornography, or other legal yet inappropriate content. Pornography may, for example, relate to visiting pornographic (adult) websites, paying for viewing pornographic content, searching for pornographic content, the downloading of pornographic content or live broadcasting of pornographic content.

Multiple user internet activities may also be performed on a user device simultaneously. Said multiple user internet activities may also be active on a user device simultaneously. The user internet activity may also comprise switching between different activities. The processor may be able to analyze and process different internet activities simultaneously.

The present invention is also advantageous when a user internet activity performed on the user device is related to an addiction, because it provides a lighting controller that may be able to regulate said user internet activity. Hence, in an embodiment, the user internet activity performed on the user device may relate to an addictive behavior. The present invention may then provide an improved lighting controller for regulating this addictive activity. Further, as it is a lighting controller, the regulation of the addictive activity may be unobtrusive, for example when the controlled light source may provide ambient, backlighting, or a light therapy. In case of a light therapy, information indicating the internet activity or the database information may be used to derive properties for the light therapy. For example, health records may comprise information on a light therapy that is effective for a particular addictive user using the user device for user internet activities. Alternatively, the properties for the lighting characteristic themselves may also be specifiable by users using the user device for user internet activity themselves. Addictive users (or their supervisors) may for example define a set of lighting characteristics that is tailored to their regulatory requirements.

As mentioned before, the user internet activity performed on the user device may comprise monetary transactions. Monetary transactions may be transactions of real currency like Dollars, Euro's, Pounds Sterling, but also fictive currency like in-game credits to buy in-game products, or digital currencies like Bitcoins. Such monetary transactions may be user internet activities that may benefit from regulatory action, particularly in case the user internet activity may be related to an addiction like spending money. Monetary transactions may also include buying products online or paying for services online. Conversely, in the case of an online retail store, an online buying activity may be maximized by stimulating the online monetary transaction activity. An online retail store may also discourage buying products by persons of interest that have a bad paying record, in case payment is done by after shipping payment. Furthermore, a user internet activity performed on a user device comprising monetary transactions may also be internet banking, wherein bills may be paid and private monetary transactions may be made.

In another embodiment, the user internet activity performed on the user device may comprise an undesired or inappropriate internet activity. Such an undesired and inappropriate internet activity may be indicated in the information receivable by the processor. Furthermore, said information may be tagged by a user through a user input device as undesired or inappropriate. For example, internet activity classified as undesired and inappropriate may be classified in the user device, such that the processor is able to recognize the user internet activity as undesired and inappropriate. The undesired and inappropriate internet activity may comprise visiting legal undesired and inappropriate websites, such as adult websites, websites with excessive violence, and websites with undesired and inappropriate propaganda.

In another embodiment, the user internet activity performed on the user device may comprise an online communicative interaction. Said communicative interactions may be texting, chatting, or videoconferencing; with for example a customer service representative (either real or artificial), a business partner or institutional representative. Said online communicative interaction may also be part of an online monetary transaction, wherein a customer service call is part of the monetary transaction process. Such an online communicative interaction may be advantageously suitable for regulation by means of controlling a light source, wherein the lighting characteristics stimulate or de-stimulate mutual trust within said user internet activity and are hence able to induce a change in the user internet activity. This change may be a more efficient, or more effective, solution of a problem, which is key to the communicative interaction. For example: a shift to online customer service is observed, wherein customers are trying to solve customer-problems by communicating with an online customer representative, wherein said problems are quicker and more effectively solved when mutual trust exists between the customer and customer representative. As mentioned before, research has shown that mutual trust may increase in warmer colored lighting environments compared to cooler colored lighting environments. The present invention is thus advantageous to improve online communicative interactions (such as customer service) by stimulating mutual trust for the user using the user device for said user internet activity. Other examples may include: online buying, selling, or negotiating for products; online communication for correcting deficiencies in monetary transactions; business negotiations; online job interviews; or contract negotiations wherein monetary transactions are comprised.

Said processor is, amongst others, arranged for processing information indicating the user internet activity on the user device. Said processor is thus in connection with the user device. In an embodiment, the processor is part of the user device. In this way, the processor—hence the regulatory action of the user internet activity—may be controlled from within the user device itself. This is advantageous, because the user device may already be enabled to host such a processor. The user device may also comprise a memory from which the processor is able to receive stored information indicating the user internet activity on the user device. In another embodiment, the processor is part of a light source. In this way the lighting controller may be located close to the light source, such that the supplied control signal may reach the controlled light source earlier without transmission losses.

In an embodiment, the lighting controller may comprise a communication device for sending and receiving information, wherein the processor may be in connection with the communication device. Further, said information may be send to or received from external devices. Said communication device may be a Wi-Fi receiver, Bluetooth antenna, RF beacon, camera or light source arranged for VLC, or ZigBee chip. By allowing such information from external devices, the obtained control signal for controlling the light source may be more accurate, such that a change in the user internet activity performed on the user device during the user internet activity may be induced more efficiently. Such external devices may be sensors, but may also be other devices or means that monitor user internet activity, either on the user device of the present invention or on other user devices. Such external devices may also be servers comprising database data.

Furthermore, as mentioned, it is advantageous to regulate a user internet activity performed on a user device. In an embodiment, the information indicating the user internet activity comprises at least one of the group of: a specific website visited, a type of website visited, a duration of a website visited, a frequency of a website visited, and a frequency of a particular item viewed on a website. By processing information related to the activities performed on the user device, such as information related to a specific website visited, the type, duration and frequency of a website visited, or a particular item viewed on a website, a more accurate assessment may be made regarding the activity to be regulated on the user device. For example, the activity on the user device may comprise visiting a shopping website, for the twentieth time, on which several hours are spend to view and buy particular undesired products. It is thus desired that the shopping activity is regulated. In such a case, the processor is arranged to supply the control signal to control the light source to colder light, which may induce a change in the user internet activity during the user internet activity, because such a colder light may discourage the activity of visiting a shopping website and buying said products online. In an embodiment, the information indicating the user internet activity comprises the time and date of the activity. Knowing the time and date of the activity may provide advantageous as activities performed at different times of day may be regulated differently. For example, at night, addictive activities may be regulated more strictly than during the day. The control signal may hence be different depending on the time of day.

In case of monetary transactions warmer light is stimulating such transactions, while colder light is not stimulating such transactions. Hence, in an embodiment of the lighting controller, wherein the user internet activity performed on the user device comprises monetary transactions, the processor may be arranged for supplying the output signal to control the light source to provide light comprising colder light for discouraging the user internet activity related to the monetary transactions; or to provide light comprising warmer light for encouraging the monetary transactions. For example: the colder light may be blue light within the white light spectrum, while the warmer light may be red light within the white light spectrum. In this way, monetary transactions may be regulated by means of the lighting controller of the present invention. This is advantageous, as monetary transactions may require regulation, even in a private environment, such as coping with buying addiction.

As partly mentioned before, the notions of ‘warmer light’ and ‘colder light’ indicate a warmer color temperature and respectively a colder color temperature on the white light spectrum. Hence, regulating an initial lighting condition to a warmer color temperature or to a colder color temperature is clear for a person skilled in the art. Changing the lighting characteristics of a light source to a warmer color temperature will thus be specified as decreasing the color temperature to a lower temperature value. This applies conversely for changing the lighting characteristic to a colder color temperature. For example, an initial color temperature may be at 1500 Kelvin, indicative of a ‘red light’ color. Subsequently increasing the color temperature to e.g. 2000 Kelvin may already be perceived as a change to a colder color temperature, although the light may still visually be a ‘reddish’ color. Conversely, decreasing the color temperature to e.g. 1000 Kelvin may already be perceived as a change to a warmer color temperature, although the light may still visually be a ‘reddish’ color. Such small incremental increases or decreases may be sufficient to induce a change in user internet activity, as in the present invention, because even a minor change towards a warmer color temperature may be perceivable as an inductive effect to change user internet activity. This appears to be an advantageous effect in case of habituation. Here, habituation indicates that a user using a user device may be habituated to an initial color temperature value. However, any increment perceivably deviating from said initial color temperature value may already induce a change in user internet activity. Such increments may be at least 100 Kelvin, for example 150K or 250K, on the color temperature range of the white light spectrum.

In an embodiment, the lighting controller is arranged for receiving and processing a sensor output provided by a sensor arranged for sensing lighting characteristics. Such sensor may for example provide sensing data on ambient lighting condition. The lighting controller may use such data for obtaining the control signal. For example, when said sensor senses an ambient lighting condition corresponding to nighttime, the lighting controller may process the sensing data to adapt or adjust the processed control signal.

The processor is able to supply a control signal to control the light source, which is arranged for inducing a change in activity on the user device. However, the regulatory action of the present invention may not always be desired without an authorization. Hence, in an embodiment, the processor is arranged for receiving an authorization for supplying a control signal to the light source. Or: the processor is arranged for receiving an authorization to control the light source. Such an authorization may be stored on a storage device on the user device in relation to the processor. Or it may be stored in the memory in which also the stored information is stored. The authorization may be a digital protocol or a user input to the user device, wherein in the latter case the lighting controller may comprise a user interface. For example, the authorization may be a user input by parents to enable regulation of the user internet activity of their children. The processor may be able to recognize the authorization, such that after recognition, the light source is accessible by the processor. Providing such an authorization is advantageous, because a lighting controller for regulating user internet activities performed on a user device may have a significant effect on the outcome of the regulated activities, hence an authorization may prove valuable before regulation is provided by the lighting controller of the user internet activities performed on the user device. A similar authorization is also discussed later in combination with a lighting system according to the invention.

The authorization may also be provided by means of a user input device in connection with the lighting controller. Such a user input device may comprise a user interface, such as a touchscreen or buttons.

According to the present invention, by means of supplying the control signal, the light source is controllable by the processor for inducing a change in the user internet activity on the user device. The light source may be a conventional incandescent type of light source, a retrofit lamp, or a semiconductor lighting device like a LED, OLED, LED strip. The light source may also be integrated within the user device, such as for example a backlight, front light, or integrated LED lighting, such as Philips Ambilight displays which are characterized by LED lighting surrounding the display. The light source may also be separate from the user device as a standalone luminaire, light spot, or pixilated light spot. The light source may also be a smart bulb like the Philips Hue or similar products. The light source may also be at least one light source, wherein the light source is part of an array of light sources, or part of a set of light sources. The light sources may provide a single coherent light effect or an individual light effect each. The light source may be multiple light sources.

The light source is able to change at least one lighting characteristic from the group of color, intensity, color temperature and modulation.

The light source may provide ambient lighting, indirect lighting, or directional lighting, such as directed to the user device or the user using the user device for user internet activity.

The light source may also be an unconventional light source, such as a television display or a smartphone display. In such cases the display is the light source. At least one lighting characteristic of the display from the group of color, intensity, color temperature and modulation may be changed. For example, the background color temperature of the display may be slightly (or unconsciously to the user of the user device performing the user internet activity) controlled to warmer color temperatures to encourage buying products. Alternatively, the background color temperature may be controlled to colder color temperature when a conference video call is performed to keep the user of the user device performing the user internet activity within the formal setting of the conference call (e.g. by discouraging a user to play around on the internet while having a conference call). Alternatively, for example, the lighting characteristics of the display may change locally such that contrast differences may induce a change in user internet activity, such as providing lighting conditions that make a logo of a product look less appealing compared to originally intended colors.

Colored light and/or color temperature may induce a change in user internet activity on the user device. Color of lighting appears to encourage or discourage activities performed on a user device. Warmer light temperatures, such as for example reddish light at lower color temperatures of the white light spectrum, may encourage activities such as shopping, paying, activities comprising mutual trust, connecting to people, donating, watching pornography, gambling or giving a rating. Colder light temperatures, such as e.g. blueish light at higher color temperatures of the white light spectrum, may adversely discourage the mentioned activities. Other exemplar colors with a steady color temperature may have similar effects. Hence, other colors of the color spectrum may also prove valuable in inducing a change in the activity on the user device.

Color of ambient or directional lighting may also change the perception of objects. For example, products on a webshop, which are displayed on a display of a user device, may look different in different color conditions. The colors of products may be accentuated by controlling a light source, or adversely be blended in the surrounding such that the products look less appealing.

For example, blue light has been shown to be more effective than green light in attenuating the increase in sleepiness and deterioration of performance. As a result, blue light may be encouraging in functional tasks related to user internet activity. For example, in research, blue light enriched office lighting increases performance in tasks, amongst which user internet activities. Another example, Blue light illumination proves to be more effective as yellow light (and also green light) with respect to alertness and speed of information processing. In a user internet activity comprising monetary transactions, wherein information on the monetary transactions needs to be processed, e.g. stock exchange activities, blueish light illumination may induce an improvement in the user internet activity. This may also apply to blue-enriched white light.

A light therapy or light scene comprising a set of colors and color temperatures may also be applied.

Light intensity may also induce a change in user internet activity on the user device. Dimmed (low intensity) light may be encouraging user internet activities such as shopping, paying, activities comprising mutual trust, connecting to people, donating, watching pornography, gambling or giving a rating. Adversely higher intensity light may be discouraging said user internet activities. However, higher intensity light may encourage other user internet activities, such as reading texts or functional activities related to work in which concentration is key (e.g. writing, calculating, and drawing).

Light modulation may also induce a change in user internet activity on the user device. For example, a user internet activity may be encouraged by a few nudges of light (shortly flickering lights) when a particular user internet activity requires encouragement, because it mimics a personal nudge of approval. On the other hand, a continuous oscillation of light output may discourage a user internet activity, because it resembles the common notion of danger or alarm. Light modulation during the time of day may also prove beneficial in regulating wakefulness and the performing of tasks.

Light modulation may also comprise lighting dynamics. Hence, providing dynamic lighting scenes, for example a sun setting scene, or a dimming scene, or providing a scene comprising a light image of rainfall with droplets. Such scenes may provide an ambient environment, wherein a user using the user device for user internet activities may perceive a slower passing of time or a faster passing of time, such that a time for thinking about a user decision may be influenced. For example, a longer thinking time for a purchase may be induced by providing a ‘holiday’ lighting scene (e.g. light source mimicking rippling water or green waving trees); or conversely lowered by providing a ‘city/traffic’ lighting scene (e.g. light source mimicking fast car traffic and car lights). Thus, for example, regulatory action may also comprise influencing a thinking time (or an emotion) of a user.

It is a further object of the invention to provide an improved lighting system, which is able to regulate a user internet activity performed on a user device by controlling a light source. Thereto, the invention provides a lighting system comprising the lighting controller according to the first aspect of the invention and the light source. Such a lighting system may provide a regulating means to regulate a user internet activity performed on a user device. Such a lighting system both comprises the lighting controller as well as the light source, which is advantageous, because the lighting controller and light source may be more dedicated to each other to achieve the object of the lighting system. Hence, the light source will always be compatible with the lighting controller. Furthermore, said lighting system may comprise a lighting controller and light source which are integrated in a single body.

The regulatory action provided by the lighting system may not always be desired without an authorization. For example, users of a user device performing user internet activities may decide by themselves whether or not to implement the lighting system according to the present invention. Furthermore, for example, other natural persons (e.g. parents) or institutions may decide whether or not to implement the lighting system according to the present invention for another user using the user device for user internet activities. Even further, for example, digital entities such as programs or websites may decide accordingly whether or not to implement the lighting system according to the present invention for a user using the user device for user internet activities. Thus, multiple examples may be given in which authorization may be desired before controlling the light source by means of the lighting controller.

Hence, the light source may only be accessible for control by means of an authorization provided to the processor of the lighting controller. Thus, in an embodiment, the processor is arranged for receiving an authorization to control the light source. Such an authorization may be stored on a storage device on the user device in relation to the processor of the lighting controller. Or it may be stored on the memory, as mentioned before, in which also the stored information is stored. The authorization may be a digital protocol or a user input to the user device. The processor may be able to recognize the authorization, such that after recognition, the light source is controllable (or accessible) by the processor. Providing such an authorization is advantageous, because a lighting system for regulating user internet activities performed on a user device may have a significant effect on the outcome of the regulated activities, hence an authorization may prove valuable before regulation is provided by the lighting system of the user internet activities performed on the user device.

Said authorization may not always be present on the user device. It may be provided by another device, such as for example another lighting system, another user device, or external server. Said authorization may also be controllable by another device, such that the authorization and thus the operation of the lighting system is dynamically provided. Hence, in an embodiment, the light source is arranged for providing an authorization to the lighting controller to control the light source, and wherein the processor is arranged for receiving said authorization. Providing the authorization to the user device from the light source may be advantageous for implementing the lighting system according to the present invention, because the authorization to access the control of the light source may already be stored within the light source itself, which allows the light source of the lighting system to be plug-and-play. Therefore, providing an authorized light source will enable the lighting system directly.

In another embodiment, an external server is arranged for providing an authorization to the lighting controller to control the light source, and wherein the processor is arranged for receiving said authorization. Providing the authorization to the lighting controller from an external server may be advantageous for implementing the lighting system according to the present invention, because the authorization to control the light source may be readily stored and maintained at the external server. For example, authorization to control the light source may be given once at a specific instance in time and stored on an external server, after which the server may provide the authorization or control the authorization as desired. Providing an external server with authorization may facilitate the accessibility to control the light source. For example, an online retailer may built a database with authorizations for multiple users, and when said users are shopping online by means of the user device of the present invention and when said users possess the lighting system of the present invention, the online retailer may be able to access the lighting system corresponding to said users and may control the light source within the lighting system for inducing a change in the user internet activity (e.g. more online buying by providing a control signal comprising warm light temperature).

Said external server may be a server in retail, server of a web shop, a bank, a casino, game host, charity, comparison website, pornographic webpage. For example: an external server of a web shop may be given initial authorization to control the light source of the lighting system. The processor of the lighting controller which is receiving the authorization from the external server, i.e. the web shop in this example, may subsequently supply the control signal (according to the invention) to control the light source. Activities performed on the user device, which relate to shopping on the web shop, may now be regulated by supplying the control signal to control the light source for inducing a change in activity on the user device during the user internet activity. In case the activity on the user device is, for example, looking to buy the cheapest product within a group, then the lighting output may be encouraging the activity on the user device whenever the cheapest product is watched by providing e.g. warm white or colors associated with warmth such as reddish colors or low-frequent modulating warmer light. This may induce a change in activity on the user device.

Yet in another embodiment, a user device is arranged for providing an authorization to the lighting controller to control the light source, and wherein the processor is arranged for receiving said authorization. Said user device may be the user device according to the first aspect of the invention, or another (further) user device not related to the first aspect of the invention. In the latter case, the user device may be a separate smartphone or wearable, which provides authorization to the lighting controller to control the light source. Said authorization may be provided by communicating the authorization to the processor of the lighting controller by means of wireless connection. In such a case the processor will be able to communicate to such a device. For example, a first user may be using the user device for user internet activities, while a second user will provide authorization to the lighting system (i.e. processor of the lighting controller) to enable the lighting system according to the invention for regulating the user internet activity. In such case the first user may be a child and the second user a parent, in which the parent desires regulation of the user internet activity of the child. In another example, the authorization may be provided by a wearable device by means of wireless connection with the lighting system. A user using the user device for user internet activities may then automatically authorize the lighting system to regulate the user internet activities.

It is also advantageous to combine the light source, lighting controller and user device within a single lighting system, because said regulatory feedback loop—from the user internet activity to the control signal to control the light source for inducing a change in the user internet activity performed on the user device during the user internet activity lighting system—may be embodied within a single lighting system. The lighting controller, light source and user device may thus be compatible with each other. Thus, in an embodiment, a lighting system is provided comprising the lighting controller according to the first aspect of the invention, the light source and the user device.

In an embodiment, the lighting system according to the invention is given, further comprising the user device, and wherein the light source is part of the user device. Having the light source as part of the user device will enable more efficient regulatory action. That is: the control signal controlling the light source to change at least one lighting characteristic from the group of color, intensity, color temperature and modulation may be supplied to the light source for inducing a change in the user internet activity performed on the user device during the user internet activity. In case the light source is part of the user device, as is in said embodiment, the lighting characteristics may be more effective to the user using the user device for user internet activities. The light source may be observed directly while performing the user internet activities. Hence, the effect of the light source may be more. For example, in an embodiment, the light source may be an array of light sources around a display on which user internet activities are performed. Said light source may illuminate the surrounding environment of the user device, such that a local ambient lighting is provided depending on the intensity of the light. In another embodiment, the light source may be an array of light sources comprised within a display on which user internet activities are performed. For example, such as backlighting of a display, or a luminous LED, OLED display itself.

In an embodiment, the lighting system according to the invention is given, further comprising an optical sensor for sensing a lighting characteristic from the group of color, intensity, color temperature, and for providing a sensor output; wherein the lighting controller is arranged for receiving and processing the sensor output as sensed information. In such an embodiment, the lighting system is able to measure ambient lighting characteristics, as for example color temperature, and process the sensed information in order to find an initial color temperature value, which may serve as a starting point for the regulatory action to regulate the user internet activity on the user device.

It is a further object of the invention to provide an improved method performed by a lighting controller for regulating a user internet activity performed on a user device. Thereto, invention further provides a method of regulating a user internet activity performed on a user device comprising an online monetary transaction, the method performed by a lighting controller, comprising a processor, and comprising: receiving information indicating the user internet activity on a user device; storing said information in a memory; processing said information to obtain a control signal for controlling a light source to change a lighting characteristic from the group of color temperature; controlling the light source for encouraging a user to perform the online monetary transaction by a decrease in color temperature, or discouraging a user to perform the online monetary transaction by an increase in color temperature.

Such a method performed by a lighting controller is advantageous because a user internet activity performed on a user device may be regulated, as it may be desired to provide regulation to such an user internet activity, by controlling the light source for inducing a change in the user internet activity performed on the user device by outputting said control signal during the user internet activity. Such a method is particularly suited for a user internet activity performed on a user device that benefits from regulatory action, such as for example repetitive, decisional or addictive activities, because research indicates that a controlling a light source may not only influence the mood or well-being of people, but it may also induce a change (e.g. encouragement or discouragement) in activities performed on a user device, such as user internet activities. Furthermore, supplying the control signal according to the method may also be read as outputting the control signal.

Controlling a light source may not only influence the mood or well-being of people, but it may also induce a change (e.g. encouragement or discouragement) in activities performed on a user device, such as user internet activities. Hence, another advantage is that a regulating means is provided for regulating a user internet activity wherein the regulatory feedback loop comprises controlling a light source. It may provide an unobtrusive means for regulating a user internet activity, e.g. by controlling a light source providing ambient lighting.

For example, a user internet activity performed on a user device may relate to online shopping. Information indicating the online shopping activity may be received by the processor according to the method. Said information may be stored, such that both real-time data and stored data may be received at a particular instance in time. Said information may be processed to obtain a control signal for controlling a light source to change the lighting characteristic of color temperature. The method may further provide the controlling of the light source for inducing a change in the online shopping activity performed on the user internet device by outputting the control signal during the user internet activity. Hence, during the user internet activity, the lighting controller may regulate the online shopping behavior as desired, that is: the light source may be controlled to for inducing a discouraging shopping effect by providing a control signal comprising cold color temperature light; or warm color temperature light for inducing an encouraging shopping effect. With such a method, as the example indicates, the user internet activity may be regulated as desired.

Alternatively, such a method may also be performed by a lighting system, comprising the lighting controller according to the first method and a light source.

The method may further comprise: accessing a database comprising database information for additionally receiving the database information to be able to additionally assess the database information in obtaining the control signal.

In an embodiment, a method is provided according any of to the method performed by a lighting controller mentioned above, wherein the user internet activity performed on the user device relates to an activity from the group of shopping, banking, gambling, gaming, donations, rating, or pornography. It may be advantageous to regulate such activities by means of a lighting controller according to the present invention, because controlling the light source may provide a subtle means to induce a change in a user internet activity (or behavior). Such user internet activities may also require regulation, as they may be more prone to addiction, repetition or decisions.

In an embodiment, a method is provided according to any of the methods mentioned above, wherein the control signal for controlling the light source comprises a colder light temperature for discouraging a user internet activity; wherein the control signal for controlling the light source comprises a warmer light temperature for encouraging a user internet activity. Such an embodiment is advantageous because the characteristic of light temperature is used for regulating a user internet activity, which is a subtle and unobtrusive characteristic to induce change in user internet activity. Alternatively, a lighting characteristic from the group of color, intensity, color temperature and modulation may be implemented to encourage or discourage a user internet activity.

In an embodiment, a method is provided according to any of the methods mentioned above, wherein the method further comprises: accessing a database comprising database information for additionally receiving the database information to be able to additionally assess the database information in obtaining the control signal. Such database information may comprise financial data, health data or personal user information data.

In an embodiment, a method is provided according to any of the methods mentioned above, wherein the method further comprises: receiving an authorization to control the light source.

The invention further relates to a computer program product. Hence, the invention provides a computer program product for a computing device, the computer program product comprising computer program code to perform the methods of the present invention mentioned above when the computer program product is run on a processing unit of the computing device. Said computer program product may be executed by the lighting system according to the invention. For example, said processing unit may also be the processor according to the invention or a separate processor provided in the user device. Performing abovementioned method by means of the computer program product may include only the features of the method implementable by means of a computer program product.

Thus, aspects of the invention may be implemented in a computer program product, which may be a collection of computer program instructions stored on a computer readable storage device which may be executed by a computer. The instructions of the present invention may be in any interpretable or executable code mechanism, including but not limited to scripts, interpretable programs, dynamic link libraries (DLLs) or Java classes. The instructions can be provided as complete executable programs, partial executable programs, as modifications to existing programs (e.g. updates) or extensions for existing programs (e.g. plugins). Moreover, parts of the processing of the present invention may be distributed over multiple computers or processors.

In an aspect of the invention, in a paragraph, there is provided: a lighting controller for regulating a user internet activity performed on a user device, wherein the lighting controller comprises a processor arranged for: receiving information indicating the user internet activity on the user device; processing said information to obtain a control signal for controlling a light source to change at least one lighting characteristic from the group of color, intensity, color temperature and modulation; and supplying the control signal to control the light source for inducing a change in the user internet activity performed on the user device during the user internet activity.

In an aspect of the invention, in a paragraph, there is provided: a lighting controller for regulating a user internet activity performed on a user device, wherein the lighting controller comprises a processor arranged for: receiving information indicating the user internet activity on the user device during the user internet activity; processing said information to obtain a control signal for controlling a light source to change at least one lighting characteristic from the group of color, intensity, color temperature and modulation; and supplying the control signal to control the light source for inducing a user to change internet activity performed on the user device during the user internet activity.

In an aspect of the invention, in a paragraph, there is provided: a method performed by a lighting controller, comprising a processor, and comprising: receiving information indicating a user internet activity on a user device; storing said information in a memory; processing said information to obtain a control signal for controlling a light source to change at least one lighting characteristic from the group of color, intensity, color temperature and modulation; controlling the light source for inducing a change in the user internet activity performed on the user device by supplying the control signal during the user internet activity.

In an aspect of the invention, in a paragraph, there is provided: A lighting controller for regulating an internet activity of a user from a first internet activity level to a second internet activity level by changing a lighting characteristic of a light source from a first lighting level to a second lighting level; wherein the first lighting level is associated with the first internet activity level, wherein the internet activity of the user is performed on a user device, and the lighting characteristic is at least one from the group of color, intensity, color temperature and modulation; wherein the lighting controller comprises a processor arranged for: receiving information indicating (i) the first internet activity level on the user device during the user internet activity, (ii) the first lighting level; receiving information indicating the (iii) second lighting level; processing said information indicating points (i) and (ii) and said information indicating point (iii) to obtain a control signal for controlling the light source to change the lighting characteristic from the first lighting level to the second lighting level; regulating the user internet activity by supplying the control signal to control the light source to the second lighting level. Processing said information may comprise determining the difference or change between the first internet activity level and the second internet activity level, and/or determining the second lighting level by providing an increment in lighting level as a function of said difference between the first user internet activity and the second user internet activity. Hence, a feedback loop or regulator is established. The second lighting level is the desired lighting level (for achieving the second internet activity level in the feedback loop established by the lighting controller). A user internet activity level may for example comprise a statistic indicating an intent to a proposition received. For example, when the proposition is online shopping behaviour, the intent to the proposition received may e.g. be the amount of views of a product viewed, click interactions of an user, etc. For example, said level may be quantified by date received indicating the user internet activity. Said data may be received from the user device directly or from an external server.

The embodiments applying to the first aspect of the invention may apply mutatis mutandis to said other aspects of the invention in the paragraphs above.

### BRIEF DESCRIPTION OF THE DRAWINGS

The invention will now be further elucidated by means of the schematic non-limiting drawings:

FIG. 1 depicts schematically an embodiment of a lighting controller for regulating a user internet activity performed on a user device, the lighting controller comprising a processor.

FIG. 2 depicts schematically an embodiment of a lighting system comprising a lighting controller according to the invention for regulating a user internet activity performed on a user device and a light source.

FIG. 3 depicts schematically an embodiment of a lighting system comprising a lighting controller according to the invention for regulating a user internet activity performed on a user device and a light source, wherein the light source is located within the user device.

FIG. 4 depicts schematically an embodiment of a method performed by a lighting controller.

### DETAILED DESCRIPTION OF THE EMBODIMENTS

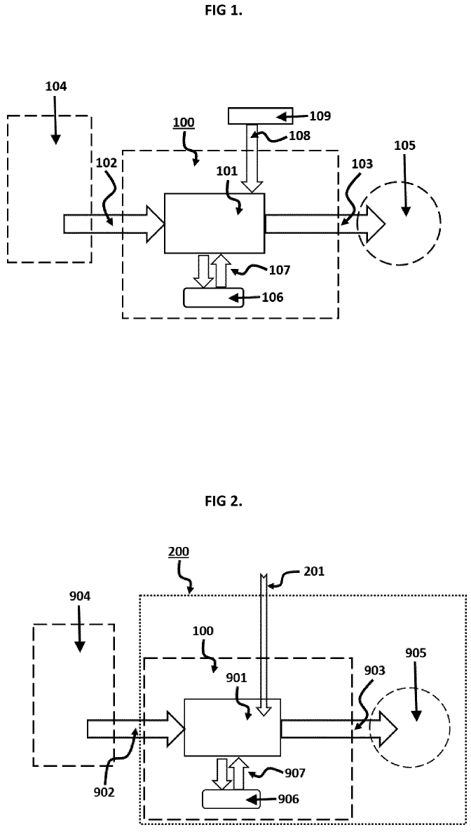

FIG. 1 depicts schematically, by non-limiting example, an embodiment of a lighting controller 100 for regulating a user internet activity performed on a user device 104. The user internet activity comprises an online monetary transaction. The lighting controller 100 comprises a processor 101 which receives information 102 indicating the user internet activity on the user device 104. The processor processes said information 102 to obtain a control signal 103 which controls a light source 105 to change at least one lighting characteristic from the group of color, intensity, color temperature and modulation. The processor of the lighting controller supplies the control signal 103 to control the light source 105 for encouraging a user to perform the online monetary transaction by a decrease in color temperature, or discouraging a user to perform the online monetary transaction by an increase in color temperature.

FIG. 1 further depicts schematically the processor 101, wherein the processor 101 optionally stores information in a memory 106 indicating the user internet activity on the user device 104 and accesses the memory 106 for additionally processing the stored information 107 in obtaining the control signal 103.

In an alternative embodiment, if no memory is present, the lighting controller which regulates the user internet activity on the user device may only receive real-time information indicating the user internet activity on the user device.

FIG. 1 further depicts schematically the processor 101, wherein the processor 101 additionally accesses a database 109 comprising database information 108. The processor 101 receives the database information 108 to additionally assess the database information 108 in obtaining the control signal 103.

In an alternative embodiment, no database may be present, wherein the lighting controller for regulating a user internet activity on a user device may only receive real-time information indicating the user internet activity on the user device and stored information in the memory. For example, the lighting controller may regulate a user internet activity related to online shopping, wherein the lighting controller is not allowed to access a database due to privacy or legal reasons. Omitting database information in obtaining the control signal may be more effective in data communication and in regulating speed of the regulatory action.

Referring to the embodiment depicted in FIG. 1, said processor 101 processes, amongst others, the information 102 indicating the user internet activity on the user device 104. The processor 101 is part of the lighting controller 100 and located in the same body embodied by the lighting controller 100. Alternatively, the processor 101 may be fully or in part located in the light source or in the user device; hence in an external device. In such a case, the processor and/or the processing power of the processor may be shared with the lighting controller.

In an alternative embodiment (not shown), the processor is connection to a communication device to send or receive wireless information from external devices external to the lighting controller. The communication device may be a Bluetooth antenna, Wi-Fi receiver, RF beacon, camera or light source suitable for Visible Light Communication (VLC). As a result, the processor may receive information indicating the user internet activity performed on the user device via wireless communication means. Consequently, also the control signal to control the light source may be send by wireless connection via said communication device. Such an alternative embodiment may provide more functionality to the lighting controller, as the lighting controller may be located separately and at a distance from the light source and the user device. Wireless communication also allows the lighting controller to connect to all suitable devices within the coverage area of the wireless communication. For example, a smart wearable device such as a smart watch may be in communication with the lighting controller, wherein the communication may comprise the sending and/or receiving information on the regulatory action of the lighting controller. A person entering a room wherein the user device, light source and lighting controller are present may for example share authorization information for regulating a user internet activity to the lighting controller by means of wireless connection.

The lighting controller 100 may be a lighting controller separate from other devices and embodied as a stand-alone lighting controller device. However, alternatively, the lighting controller may still be an autonomous device, but integrated within the body of the user device or the light source. This may facilitate the receiving and processing of the information indicating the user internet activity.

In an alternative embodiment, the lighting controller may be part of an application or computer program product present on a user device, which may be either the user device on which the user internet activity is performed, or another ‘third’ user device. In such a case, the processor of the user device (e.g. display or smartphone) may be shared with the lighting controller. For example, the another user device may be a light source, such as a smart light bulb, wherein the lighting controller according to the invention and the light source share one processor. Yet alternatively, the lighting controller according to the present invention may be part of another separate stand-alone device, such as for example a bridge, smartphone that is not the user device, or another lighting controller device.

The user device 104 may be a smartphone. A smartphone is a device suitable for performing the user internet activity. A smartphone is a device which is particularly suited for the activities mentioned in this application. Alternatively, in other embodiments, said user device may be a tablet, a notebook, a personal computer, a game console, an e-reader, a smart fridge, or a smart TV. In case of a smart fridge, the smart fridge comprises an internet connection and a display for user internet activities.

The memory 106 additionally provides information indicating the user internet activity on the user device, but now the information is stored information. The stored data may be history data indicating the past user internet activity on the user device. For example, the stored information may comprise past records indicative of regulating the user internet activity, and/or cumulative information on the user internet activity. Such information may be taken into account when all the received information is processed to obtain the control signal. Making use of stored information may be advantageous, because more information may be evaluated in obtaining the control signal for controlling the light source. This allows for improved regulation of the user internet activity. Said memory 106 is located within the lighting controller and is accessible by the processor 101. Alternatively, in other embodiments, the memory may be located in an external memory device, such as a flash memory device or a hard disk drive. The memory may also be a memory in a user device the memory may also be accessible by the internet through the user device, such as a remote server.

The control signal 103 which controls the light source 105 to induce a change in the user internet activity performed on the user device 104 is supplied during the user internet activity. Hence, the control signal 103 provides direct regulatory action. The control signal 103 is obtained from processing real-time received information 102 and previously stored information 107 in the memory 106. Database information 108 is also accessible for further receiving information to obtain the control signal 103. The information indicating the user internet activity may provide an incentive to also access a database for retrieving database information. The database may be accessible via the internet or may be initially stored on the memory of the lighting controller or user device. Said control signal 103 may only comprise real-time received information 102 in case no stored information 107 is required for regulating the user internet activity. It is noted that real-time information 102 may also be stored temporarily in the memory 106 and then received as stored information 107, with minor time delay, for convenience in processing. Further, said control signal 103 is an electrical signal originating from the processor. Said control signal 103 controls a light source 105 to change at least one lighting characteristic from the group of color, intensity, color temperature and modulation. Modulation may e.g. include light color modulation, light intensity modulation and light direction modulation. Said control signal (130) may also comprise multiple signals, for example: multiple signals for multiple light sources, or signals for controlling light sources which are part of other type of devices.

Still referring to the embodiment depicted in FIG. 1, the processor controls the light source to induce a change in the user internet activity on the user device. The light source is able to change at least one lighting characteristic from the group of color, intensity, color temperature and modulation. The light source 105 is a LED light spot within a luminaire. The user device falls within the lighting coverage area of the luminaire. The luminaire illuminates a region wherein the user device is present, such as for example a room. Alternatively, the light source may be a conventional incandescent type of light source, a retrofit lamp, or a semiconductor lighting device like a LED, OLED, LED strip, pixilated LED—which may be embodied within a luminaire or in a user device. For example: the light source may also be integrated within the user device, such as for example a backlight, front light, or integrated LED lighting, such as Philips Ambilight displays which are characterized by LED lighting surrounding the display. In the embodiment shown in FIG. 1, the light source is separate from the user device as a standalone LED light spot. The light source may for example be a smart bulb like the Philips Hue or similar products. Alternatively, the light source may also be at least one light source, wherein the light source is part of an array of light sources, or part of a set of light sources. The light sources may provide a single coherent light effect or an individual light effect each. Hence, the light source may be multiple light sources in other embodiments.

The user internet activity performed on the user device 104 comprises a shopping activity and monetary transactions. The user internet activity is visiting an online shopping website, browsing through products, adding products to the shopping cart, and checking out by online payment. Such an activity may be undesired as it may comprise an addictive shopping behavior. The lighting controller regulates the online shopping activity and the payments related to it. The processor 101 of the lighting controller 100 receives information 102 indicating the user internet activity on the user device 104. Hence, the processor receives information on the specific online shopping website visited and the duration spend on said website. The processor 101 also receives stored information 107 stored on the memory 106. For example, the processor receives the frequency of the online shopping website visited and the frequency of a particular item viewed on this website. Alternative observations indicating the user internet activity may also be received, such as on-screen movement, on-screen clicking behavior, filling of queries, selection of items, enlarging pictures, calculating costs, adding or eliminating items in a shopping cart. The processor 101 is further accessing database 109 for receiving database information 108. The database information comprises the online shopping history of the user using the user device for user internet activities, from which it may be derived that said user is excessively buying products. The database information may further comprises health data inferred from a health report, wherein it is clear that said user is a shopping addict or is at least prone to addictive behavior. Said database information 109 is assessed together with the received real-time information 102 and the stored information 107 to obtain the control signal 103 for controlling the light source 105. This assessment may be as follows: whenever a shopping website is visited more than above a pre-determined regulatory frequency threshold, and/or whenever a product is viewed on a shopping website above a pre-determined regulatory viewing threshold, and/or whenever the database information indicates excessive shopping in the past, a discouraging control signal (as mentioned before) may be obtained. Said control signal 103 for controlling the light source is subsequently supplied to induce a change in the user internet activity performed on the user device 104 during the user internet activity. By changing the color and color temperature of the LED light spot (i.e. light source 105) to colder lighting conditions (e.g. from higher to lower whites or colors with warmer (e.g. reddish) light to cooler (e.g. blueish) light), a change is induced with respect to the user internet activity performed on the user device, because research indicates that colder color (temperatures) lighting may discourage shopping behavior, and conversely that warmer color may encourage shopping behavior.

In an alternative embodiment, the user internet activity performed on the user device 104 comprises online gambling. The processor of the lighting controller receives information indicating the online gambling activity. This may be real time data such as the type of game played, the credit at a certain moment in time, the amount of games played. This may also be stored information such as the credit history and success rate of the user using the user device for online gambling activity. The processor also receives database information. By means of a wireless connection to a user device, the processor receives database information on the physiological condition, such as heartrate and blood pressure, of the user using the user device for the online gambling activity. This user device may be a wearable device. Database information may be the gambling history of said user. A more effective control signal is obtained for controlling the light source by means of all of said information. In case the online gambling activity is desired for leisure, and the physiological conditions of said user indicate no unsound (e.g. registered) health conditions, the control signal may comprise a lighting characteristic to change the intensity to a lower setting for creating a more comfortable environment (like in real casino's) and decrease the color temperature (from neutral white) to warm red light to induce more spending of money (as research indicates that people spend more in settings with warmer color temperature). In case the online gambling activity is not desired, or when the physiological properties of said user deteriorate such as high blood pressure or heartrate, the lighting controller may generate a control signal for controlling the light source, to change the lighting characteristics to a colder color temperature (to reduce spending of money), higher intensity light (to create a more formal environment to keep focus of gambling) or a continuous subtle modulation of light (to indicate an alarm status).

In an alternative embodiment, the user internet activity performed on the user device 104 comprises rating a hotel on a comparison website. The lighting controller regulates the rating activity. Information indicating the user rating activity, such as initializing the rating process by browsing or moving to the rating functionality or by clicking on the rating functionality, are received by the processor. By processing said information a control signal is supplied to control the light source to induce a change in the rating activity performed on the user device during the rating activity. Hence the control signal may comprise warmer color temperature light to encourage the user using the user device for rating to rate a hotel higher, because warmer light may provide a lighting environment wherein said user feels e.g. more comfortable. This lighting may be ambient lighting in a room. In further alternative embodiments, said rating activity may comprise rating on a crowdsource website or rating of a video on social media.

In an alternative embodiment, the user internet activity performed on the user device 104 comprises visiting websites related to pornography and paying for pornography. Such activity may be undesired as the user using the user device for the user internet activity may be a minor or sex addict. Information on the type of pornographic website visited, the amount of money payed to enter specific pages, the payment itself, the time spend on visiting the websites are processed by the processor to obtain a control signal. Stored information is used to obtain the control signal. The stored information comprises the history of visiting the pornographic websites, the activities performed on said websites and previous payments. The control signal for controlling the light source is subsequently supplied for inducing a change in the user internet activity performed on the user device during the user internet activity. The user device is a tablet touch screen display on which the internet activity is performed. The light source is the set of light sources surrounding the display and light sources within the display on which the user visits the websites related to pornography. By changing the color and color temperature of the lighting surrounding and within the display to colder blue lighting conditions, a change is induced with respect to the user internet activity performed on the user device, because research indicates that an increase in color temperature to colder blue lighting (from e.g. neutral white or red lighting) discourages payments. The control signal also comprises a signal to change the intensity and modulation of said light source. By increasing the brightness of the display and modulating the lighting, the user using said display will be discouraged (or at least made discomfortable) to continue visiting pornographic websites. Hence, a regulatory action is provided by the lighting controller. The same approach may be used for any other website which is considered to provide inappropriate content to a particular user and for which a frequency of visiting, a duration of visiting and/or an amount of money spend should be limited.

In an alternative embodiment, the user internet activity performed on the user device 104 comprises the online communicative interaction of texting/chatting with a customer representative to solve a customer problem. Such an activity requires mutual trust to resolve the customer problem efficiently and effectively, because mutual trust enables an improved communication. The processor of the lighting controller receives information indicating the online texting/chatting with the customer representative. This may be audio data or transcript data of the texting. The processor processes said information. In some cases, it may be desired to increase mutual trust between the user using the user device and the online customer representative. Alternatively, a single sided mutual trust may be increased for the user, for example when the customer representative comprises a bot with some artificial intelligence. Subsequently: by processing said information a control signal is supplied to control the light source to induce a change in the online communicative interaction performed on the user device during the texting/chatting activity. Hence the control signal may comprise warmer color temperature light to enhance mutual trust of the user using the user device for solving a customer problem during the user's communicative interaction with the customer service representative, because research indicates that warmer light may provide a lighting environment wherein said user feels more mutual trust.

FIG. 2 depicts schematically, by non-limiting example, an embodiment of a lighting system 200 comprising the lighting controller 100 according to the invention and the light source 905. The lighting controller 100 comprises a processor 901 that receives information 902 indicating the user internet activity on the user device 904. The processor 901 processes said information 902 to obtain a control signal 903 to control a light source 905 to change at least one lighting characteristic from the group of color, intensity, color temperature and modulation. The processor further supplies the control signal 903 to control the light source 905 to induce a change in the user internet activity performed on the user device 904 during the user internet activity. The processor 901 optionally stores information in a memory 906 indicating the user internet activity on the user device 104. The processor 901 optionally accesses the memory 906 to receive and process the stored information in obtaining the control signal 903.

Referring to the embodiment depicted in FIG. 2, the light source 905 is an array of connected light sources present in a room. This includes luminaires on the ceiling, lighting devices present in the room such as lamps or Philips Living Colors lighting, and light sources integrated in other devices such as Ambilight televisions or smart furniture lighting. The user device 904 may be a smartphone, tablet, or desktop PC present in said room. The user internet activity performed on the user device 904 comprises online monetary transactions such as buying products. Alternatively, the user internet activity may be buying on a stock exchange; or buying credits within a game; or buying instantaneous media content like videos and movies.

Here, the lighting controller 100 is part of an application running on the user device. The processor 901 may be shared with the processor of the user device. The memory is similarly shared, but may alternatively be a separate memory device for example a XD cart. In an alternative embodiment representing the lighting system, the lighting controller is a stand-alone device, such as a bridge. In yet an alternative embodiment representing the lighting system, the lighting controller and light source are embodied within the same device body of the lighting system. The lighting system may thus be a smart light bulb, wherein the lighting controller and light source are integrated in a single device.

The lighting controller 100 is connected to the light source 905 by means of wireless ZigBee connection (not shown). This may alternatively be Wi-Fi, Bluetooth, RF or VLC. As a result, a lighting system 200 is provided for regulating a user internet activity performed on a user device 904. The user internet activity of buying products may not be desired, as the user using the user device (smartphone) may not be qualified to do so, or may be a shopping addict, or may be a minor under custody. The lighting system 200 may regulate the online buying activity. The processor 901 of the lighting controller 100 receives information 904 indicating the user internet activity on the user device 904. This information comprises data on the online buying, the quantities and the type of transactions. The processor 901 also receives stored information 907 stored on the memory 906. Hence the processor 901 receives stored information 907 on the buying history performed on the user device 904. Said received information (both real-time 902 as stored 907) is processed to obtain a control signal 903 for controlling the array of light sources 905. For example, whenever a product or commodity is being bought with a value higher than a regulatory threshold, and/or whenever stored information indicates that there is insufficient credit remaining or that the duration of a debt has passed a regulatory time limit, then a discouraging control signal (as mentioned before) may be obtained. Said control signal 103 for controlling the light source 905 is subsequently supplied to induce a change in the user internet activity performed on the user device 104 during the user internet activity. Said control signal 903 is provided to each of the light sources within the array of light sources 905 by means of the wireless ZigBee connection (not shown). By changing the color temperature of the light source 905 to colder color temperature conditions, a change is induced with respect to the user internet activity performed on the user device, because research indicates that lighting with a colder color temperature may discourage buying.

Still referring to the embodiment depicted in FIG. 2, the processor (910) further receives an authorization 201 to control the light source 905. The regulatory action provided by the lighting system 200 may not always be desired without an authorization 201. Here, the authorization 201 is provided by an external source. To be more specific: the authorization is available on a part of the memory of the user device 904, such that particular users using the user device 904 for user internet activity of buying will be able to be regulated. The authorization may for example be provided by parents on the smartphone of children. Or by doctors on smartphones of shopping addicts. In an alternative embodiment (not shown), the authorization may be provided by an external server. Hence, the processor 901 receives an authorization to control the light source 905. Such an external server may be the server of an online retail store, the server of an institutional database comprising personal or health information, the server of an institutional database comprising user authorizations, a personal server of a natural person, or a server of a market authority.

In an alternative embodiment (not shown) the processor (901) receives an authorization 201 to control the light source 905. The authorization 201 is provided by the light source 905, which comprises a digital protocol to provide a lighting controller 100 according to the invention with an authorization 201. This may be plug-and-play light sources (within lighting devices) in which an authorization is already present since production.

In an alternative embodiment (not shown), the authorization may also be provided to the lighting controller by means of a user input device. Said user input device may be part of the lighting controller or may be in connection with the lighting controller. The user input may be provided by means of a user interface, such as a touch interface, wherein the user input device is a touchscreen.

FIG. 3 depicts schematically, similar to the embodiment in FIG. 2, an embodiment of a lighting system 300 comprising the lighting controller 100 according to the invention and a light source 805, wherein the light source 805 is part of the user device 804. Here, the user device 804 is a smart television on which the user internet activity of watching pornographic content is performed. This may alternatively be browsing through a webshop to buy products. The light source 805 is LED lighting integrated in the display of the smart television 804. For example the backlight of an LCD display or the LEDs of an OLED display. Alternatively, the light source may surround the smart television. The information indicating the user internet activity 802 comprises the type of pornographic content browsed and the cursor movement and behavior on the pornographic content. The processor 801 of the lighting controller 100 receives information 802 indicating the user internet activity on the user device 804. The processor 801 also receives stored information 807 stored in the memory 806. Hence the processor 801 receives the history and frequency of watching the pornographic content. Said received real-time information 802 and the stored information 807 are processed to obtain the control signal 803 for controlling the light source 805. Said control signal 803 for controlling the light source 805 is subsequently supplied to induce a change in the user internet activity performed on the user device 804 during the user internet activity. By changing the intensity and modulation of the LED lights within the display of the smart television 804 to maximum bright conditions and subsequently a modulation of the brightness, a change is induced with respect to the user internet activity performed on the user device 804. Increasing the brightness will induce the subconscious perception of a more formal environment, wherein pornographic content is consumed less due to the formal setting. The modulation of intensity will induce an alarm mimicking condition, for example such that the user internet activity is flagged as inappropriate by the lighting characteristic of modulation. Due to these clearly perceptible lighting effects, a change in the user internet activity is induced and hence the undesired user internet activity regulated.

Referring to the embodiment depicted in FIG. 3, the lighting system 300 comprises a lighting controller 100, light source 805 and user device 804, wherein the latter two are integrated. The lighting controller is a separate device which is in connection with the user device 804 and light source 805. This connection is a wireless Wi-Fi connection, but may alternatively be a hardwired connection, Bluetooth, ZigBee, RF or VLC. Furthermore, alternatively, the lighting controller 100 may also be integrated in the user device 804, such that the lighting system 300 is embodied within a single device.

The processor of the lighting system 300 receives an authorization 201 to control the light source 805. Said authorization is provided by means of wireless connection (not shown) to the processor 801 by another user device, such as a smartphone. Such an authorization is beneficial, as the lighting system will be instructed when to regulate a user internet activity and when not to regulate a user internet activity. Authorization to control the light source may also depend on the user internet activity. For example, in case the user internet activity does not comply with the conditions of the authorization, the authorization may not be provided. Alternatively, the authorization may be stored in a memory, a server or database, for example within the user device itself, such that each user device may already comprise the authorizations for various users using the user device for user internet activities.

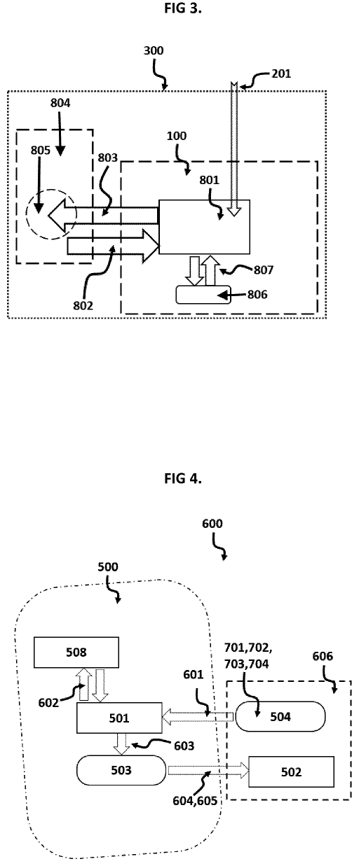

FIG. 4 depicts schematically, by non-limiting example, an embodiment of a method performed by a lighting controller, comprising a processor 501. The method performs the steps of: receiving information 601 indicating a user internet activity on a user device 504,701,702,703,704; storing said information 602 in a memory 508; processing said information 603 to obtain a control signal 503 for controlling a light source 502 to change 606 at least one lighting characteristic from the group of color, intensity, color temperature and modulation; controlling 602 the light source 502 for inducing a change 606 in the user internet activity performed on the user device 504 by supplying 605 the control signal during the user internet activity.

The user device here may be a desktop computer. The light source may be a luminaire such as a table lamp close to the desktop computer and providing lighting conditions to the display screen and/or user input devices of the desktop computer. The user internet activity performed on the user device 504 may be online shopping and buying products. This user internet activity 504 may be undesired, as the user using the user internet activity 504 may have a shopping addiction or no credit on the bank account. Information 601 indicating the user internet activity on the desktop computer 504 comprise the website visited 701, data on browsing through products 702, adding products to the shopping cart 703, checking out by online payment 704. Such an activity may be undesired as it may comprise an addictive shopping behavior. The method performed by a lighting controller 500, comprising a processor 501, may be implemented for regulating the online shopping and buying activity.

By changing the color and color temperature of the table lamp 502 (i.e. light source and hence the lighting environment related to the light source) to colder color temperature lighting conditions, a change 606 is induced with respect to the user internet activity performed on the user device 504, because research indicates that colder color temperature lighting may discourage online shopping and buying behavior.

1. A lighting controller for controlling a light source to provide ambient lighting during a user internet activity performed on a user device, wherein the user internet activity performed on the user device comprises an online monetary transaction, wherein the lighting controller comprises a processor arranged for:
receiving information indicating the user internet activity on the user device;
processing said information to obtain a control signal for controlling a light source to change a lighting characteristic from the group of color temperature; and
supplying the control signal to control the light source during the online monetary transaction, so as to decrease color temperature for encouraging a user to perform the online monetary transaction, or to increase color temperature for discouraging a user to perform the online monetary transaction by.

2. The lighting controller according to claim 1, wherein the processor is further arranged for:
storing information in a memory indicating the user internet activity on the user device; and
accessing the memory for additionally receiving the stored information to be able to additionally assess the stored information in obtaining the control signal.

3. The lighting controller according to claim 1, wherein the processor is further arranged for:
accessing a database comprising database information for additionally receiving the database information to be able to additionally assess the database information in obtaining the control signal.

4.The lighting controller according to claim 1, wherein the user internet activity performed on the user device comprises an activity from the group of shopping, banking, gambling, gaming, donations, rating, or pornography.

5. The lighting controller according to claim 1, wherein the processor is arranged for:
receiving an authorization to control the light source;
recognizing the authorization; and
regulating the user internet activity by supplying the control signal to control the light source after recognizing the authorization.

6. The lighting controller according to claim 1, wherein said increase in color temperature or said decrease in color temperature comprises an increment of at least 100 Kelvin with respect to an initial color temperature value.

7. A lighting system comprising the lighting controller according to claim 1 and the light source.

8. The lighting system according to claim 7, wherein the processor is arranged for receiving an authorization to control the light source.

9. The lighting system according to claim 7, wherein the light source is arranged for providing an authorization to the lighting controller to control the light source, and wherein the processor is arranged for receiving said authorization.

10. The lighting system according to claim 7, wherein an external server is arranged for providing an authorization to the lighting controller to control the light source, and wherein the processor is arranged for receiving said authorization.

11. The lighting system according to claim 7, further comprising the user device, and wherein the light source is part of the user device.

12. A method of controlling a light source to provide ambient lighting during a user internet activity performed on a user device comprising an online monetary transaction, the method performed by a lighting controller, comprising a processor, and comprising:
receiving information indicating the user internet activity on a user device;
storing said information in a memory;
processing said information to obtain a control signal for controlling a light source to change a lighting characteristic from the group of color temperature;
controlling the light source by supplying the control signal to control the light source during the online monetary transaction, so as to decrease color temperature for encouraging a user to perform the online monetary transaction, or to increase color temperature for discouraging a user to perform the online monetary transaction.

13. (canceled)

14. The method according to claim 12, wherein the method comprises:
receiving an authorization to control the light source.

15. A non-transitory computer readable medium comprising computer program product for a computing device, the computer program product comprising computer program code to perform the method of claim 12 when the computer program product is run on a processing unit of the computing device.

16. The lighting controller according to claim 1, wherein the information indicating the user internet activity on the user device comprises an adding or an eliminating of items in an online shopping cart.
